(19) United States
(12) Patent Application Publication
(10) Pub. No.: US 2018/0012560 A1
(43) Pub. Date: Jan. 11, 2018

(54) DETERMINATION OF PRESENCE OF REFLECTION OF A SCREEN LIGHT TO A DISPLAY SCREEN FOR SCREEN LIGHT BRIGHTNESS ADJUSTMENT

(71) Applicant: Intel Corporation, Santa Clara, CA (US)

(72) Inventor: Kaining Yuan, Shanghai (CN)

(21) Appl. No.: 15/546,275

(22) PCT Filed: Feb. 26, 2015
(86) PCT No.: PCT/CN2015/073299

§ 371 Date: Jul. 25, 2017

(51) Int. Cl. G09G 5/10

(52) U.S. Cl. CPC G09G 5/10; G09G 2360/145; G09G 2320/0626; G09G 2360/144

(57) ABSTRACT

Embodiments of the present disclosure provide techniques and configurations for an apparatus for display screen light brightness adjustment. In one instance, the apparatus may include a display screen with a screen light having a brightness value. The apparatus may include one or more sensors disposed in the apparatus to measure ambient light and to measure one or more parameters indicative of a presence or absence of reflection of the screen light to the display screen, wherein the reflection contributes to the ambient light measurement. The apparatus may further include and a processing module coupled with the sensor module to adjust or cause to be adjusted the brightness value of the display screen light, based at least in part on the measurements of the ambient light and the parameters indicative of presence or absence of reflection of the screen light to the display screen. Other embodiments may be described and/or claimed.

### FIELD

Embodiments of the present disclosure generally relate to the field of sensor devices, and more particularly, to providing computing device screen brightness in view of determined presence or absence of reflection of the screen light directed at the screen.

BACKGROUND

Today's computing devices, such as laptop computers, tablets, and smartphones may be equipped with different types of sensors, such as with ambient light sensors (ALS), used to measure ambient light and help adjust screen brightness to save power and also to make user's eyes comfortable, depending on ambient light. However, in some instances, ambient light measurements may provide incorrect results, causing erroneous screen brightness adjustment. For example, the screen light may be reflected off a particular surface, such as keyboard, back to the screen, causing erroneous measurement of ambient light and the screen light brightness increase in response to this ambient light measurement. The increase of screen light brightness may cause the light reflection to the screen to increase, which in turn may cause subsequent increase in screen light brightness, resulting in an unwanted positive feedback. Due to the positive feedback, the screen light brightness may be eventually adjusted to an undesirable, e.g., maximum level, causing an unwanted use of power.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a block diagram illustrating an example apparatus with display screen light brightness adjustment, incorporated with the teachings of the present disclosure, in accordance with some embodiments.

FIG. 2 illustrates an example apparatus configured with display screen light brightness adjustment, based in part on the presence or absence of reflection of the screen light to the display screen, in accordance with some embodiments.

FIG. 3 illustrates another example apparatus configured with display screen light brightness adjustment, based in part on the presence or absence of reflection of the screen light to the display screen, in accordance with some embodiments.

FIG. 4 is a process flow diagram for providing display screen light brightness adjustment, based in part on the presence or absence of reflection of the screen light to the display screen of an apparatus, in accordance with some embodiments.

FIG. 5 is a process flow diagram for determining presence or absence of reflection of the screen light to the display screen of an apparatus, in accordance with some embodiments.

FIG. 6 illustrates an example computing device suitable for use to practice aspects of the present disclosure, in accordance with some embodiments.

### DETAILED DESCRIPTION

Embodiments of the present disclosure include techniques and configurations for screen light brightness adjustment of a display screen of an apparatus (e.g., computing device), based at least in part on measurements of ambient light and on determination of presence or absence of reflection of the screen light to the display screen that, if present, may contribute to the measurements of the ambient light.

In accordance with embodiments, the apparatus may comprise a display screen, having a screen light with a brightness value. One or more sensors disposed in the apparatus may be configured to measure ambient light and to measure one or more parameters indicative of presence or absence of reflection of the screen light to the display screen, wherein the screen light reflection, when present, may contribute to the ambient light measurement. The apparatus may further comprise a processing module coupled with the sensor module to adjust or cause to be adjusted the brightness value of the display screen light, based at least in part on the measurements of the ambient light and the one or more parameters indicative of the presence or absence of reflection of the screen light to the display screen.

For example, readings of ambient light and readings of one or more parameters indicative of a reflection of a screen light to a display screen of the computing device may be obtained from the sensor or sensors disposed in the computing device. If the measured ambient light is determined to be above a threshold, the determination may be made that the brightness of the display screen may need to be adjusted (e.g., increased). It may also be determined from the parameters indicative of the reflection of the screen light to the display screen that the screen light may be reflected back to the screen. The reflected light may cause an incorrect ambient light measurement and subsequent increase of the display screen light brightness in response to that measurement, e.g., a positive feedback. To avoid undesirable increase of the screen light brightness, the brightness value of the display screen may be adjusted based on the measurement of ambient light and in view of the determination that the screen light may be reflected back to the display screen. For example, the brightness value may be adjusted to a particular value, such as about 20% of the maximum screen light brightness, in order to save power of the computing device during the presence of the screen light reflection to the display screen.

In the following detailed description, reference is made to the accompanying drawings that form a part hereof, wherein like numerals designate like parts throughout, and in which are shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical, electrical, or optical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

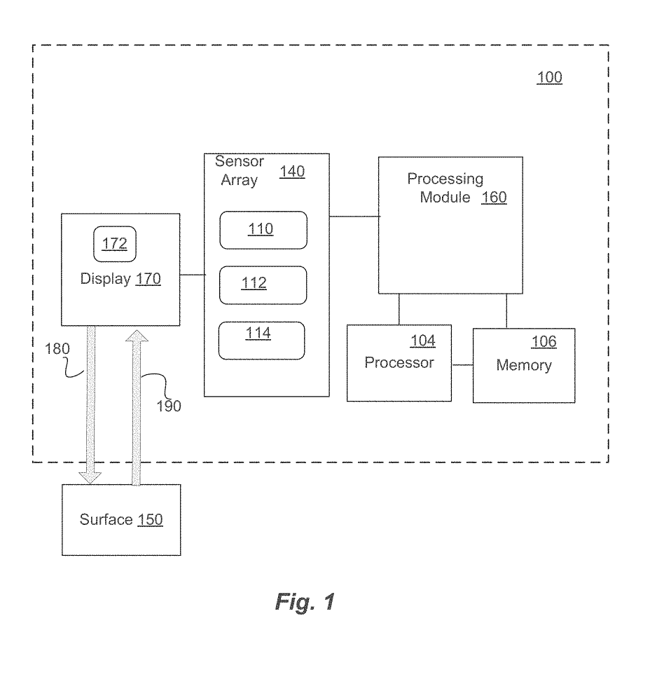

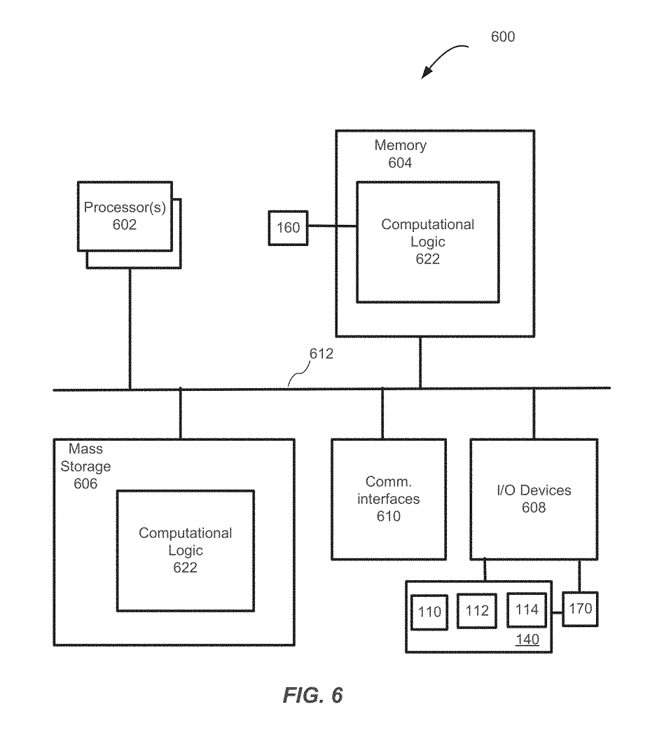

FIG. 1 is a block diagram illustrating an example apparatus 100 with display screen light brightness adjustment, incorporated with the teachings of the present disclosure, in accordance with some embodiments. The apparatus 100 may comprise a computing device. For example, the apparatus 100 may comprise a laptop computer, a tablet computer, a smartphone, a netbook, a notebook, an ultrabook, a personal digital assistant (PDA), an ultra mobile PC, or any other mobile computing device. The apparatus 100 may include, for example, a processor 104, memory 106, and a display screen 170 having a screen light source 172. An example configuration of the apparatus 100 comprising a computing device will be described below, with references to FIG. 6.

The apparatus 100 may further include a sensor array 140. The sensor array 140 may include one or more sensors 110, 112, 114 that may provide readings related to various functions and/or attributes associated with apparatus 100. For example, the sensors 110, 112, 114 may comprise an ambient light sensor (ALS), a gyroscope, a proximity sensor, screen position measurement sensor (e.g., screen hinge rotation degree measurement sensor), accelerometer, and/or other sensor types. Some of the sensors 110, 112, 114, such as, for example, ALS, may be disposed on the display screen 170, for example, on a bezel (not shown) of the display screen 170. More generally, different types of sensors 110, 112, 114 providing readings of apparatus context, such as apparatus 100′s position relative to horizontal plane, proximity to other objects, posture, and the like may be disposed about (e.g., embedded in) the apparatus 100. It should be noted that the number of sensors illustrated and types of sensors provided are for illustration purposes only and are not to be construed as limiting on this disclosure.

In embodiments, at least one of the sensors 110, 112, or 114 disposed in the apparatus 100 may be configured to measure ambient light. The sensor to measure ambient light may include an ALS mentioned above or any other sensor configured to measure ambient light characteristics, such as light intensity (e.g., brightness), light frequency (e.g., color balance), or the like.

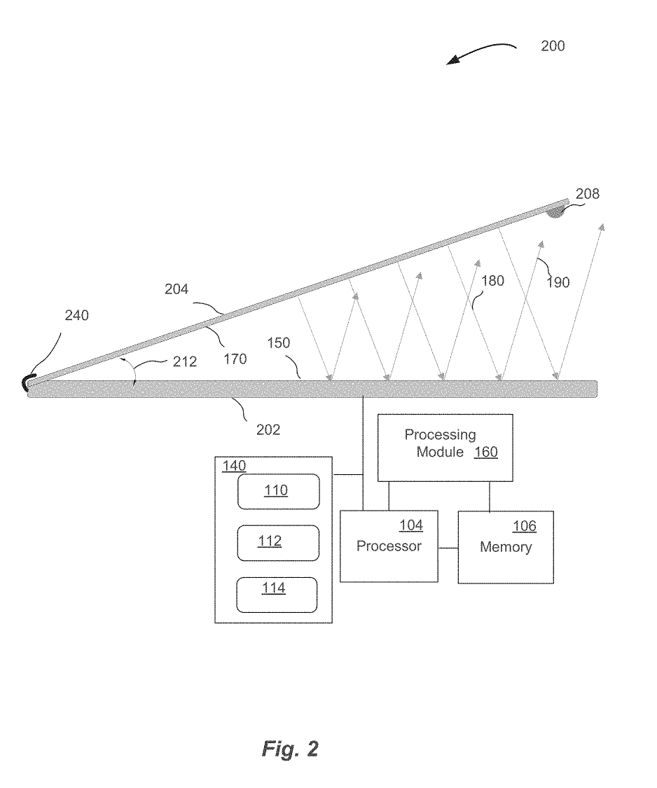

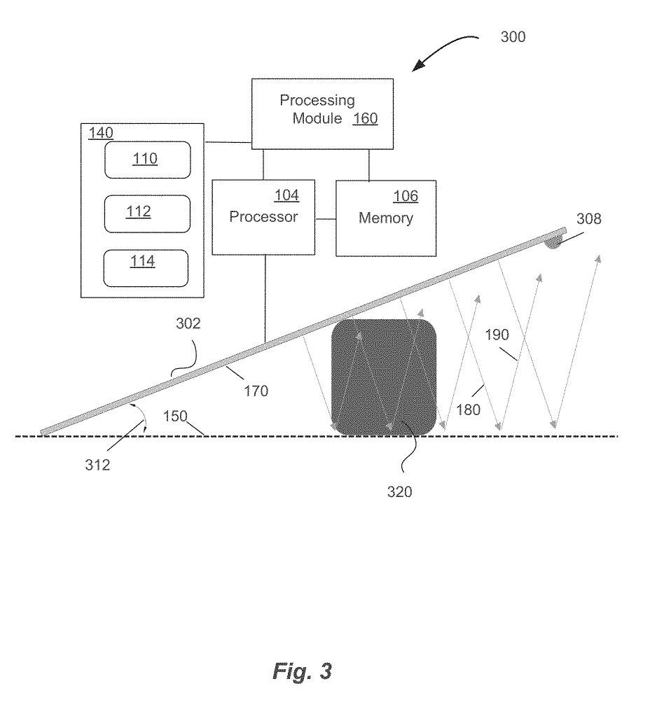

In some instances, ambient light measurements may be affected by external factors. For example, at least a portion of light 180 produced by the screen light source 172 of the display screen 170 may be reflected off a surface 150, as indicated by arrow 190. The surface 150 may comprise, for example a portion of a keyboard of the apparatus 100, if the apparatus 100 is a laptop. More generally, the surface 150 may comprise any reflective surface (internal or external to the device 100) that may be located in proximity to the display screen 170 and under an angle to the display screen 170, allowing for reflection of the screen light 180 and direction of at least a portion 190 of the reflected light back to the display screen 170, which may be captured by a sensor to measure ambient light (e.g., ALS). For simplicity purposes, hereinafter, “reflected screen light,” “screen light reflection,” and “reflection” will be used interchangeably. Examples of screen light reflections associated with different types of apparatus 100 will be described in reference to FIGS. 2-3.

The reflected screen light 190 may contribute to, or affect, the ambient light measurement by the ALS 110, 112, or 114. For example, ambient light may be measured as having a brightness value that may be higher than the ambient light brightness if measured without the light reflection at the display screen 170. Accordingly, the screen light source 172 brightness may be adjusted (e.g., increased) to compensate for the ambient light brightness increase, as measured by the ALS 110, 112, or 114. The increased brightness of the screen light source 172 may in turn cause the brightness of the reflected light 190 to increase, causing the ambient light, as measured by the ALS 110, 112, or 114, to increase even more. This positive feedback, if continued, may eventually cause the adjustment of the brightness of the screen light source 172 to its highest value. Accordingly, power may be undesirably spent for powering the screen light source 172 without particular need. The power waste may be critical in some instances, for example, when the apparatus is a portable device.

Thus, the reflection 190 of the screen light 180 back to the display screen 170, if present, may contribute to the ambient light measurement and cause a positive feedback described above. The embodiments of the present disclosure provide for detecting the screen light reflection 190 that may cause the positive feedback. The embodiments of the present disclosure further provide for the screen light source 172 brightness adjustments that take into account the positive feedback caused by reflection when reflection of the screen light to the screen is detected or at least the probability of such reflection is determined. For example, some of the sensors 110, 112, 114 may be configured to measure and provide readings of one or more parameters that may indicate presence or absence of reflection 190 of the screen light 180 to the display screen 170. The presence (at least, a possibility of presence) or absence of the screen light reflection 190 to the display screen 170 may be determined as described below.

The apparatus 100 may further include other components to facilitate sensor data aggregation and processing. For example, the apparatus 100 may include a sensor aggregator (e.g., sensor hub, not shown) coupled with sensor array 140 and configured to aggregate data provided by the sensor array 140, for further processing. The number and configuration of the apparatus 100 components to facilitate sensor data aggregation and processing may vary and is not the subject of the present disclosure.

The apparatus 100 may further include a processing module 160 coupled with the sensor array 140 (and other components to facilitate sensor data aggregation) and configured to process the readings provided by the sensor array 140 and to adjust, or cause to be adjusted the brightness of light source 172 of the display screen 170 according to the processed readings. For example, the processing module 160 may be configured to adjust or cause to be adjusted the brightness value of the display screen light, based at least in part on the measurements of the ambient light and the one or more parameters indicative of the presence or absence of reflection 190 of the screen light 180 to the display screen 170. The processing module 160 may be stored in memory 106 and may be executable on the processor 104. In alternate embodiments, the processing module 160 may be implemented in hardware, e.g., Application Specific Integrated Circuit (ASIC), or programmable circuits, such as, Field Programmable Gate Arrays (FPGA) programmed with the operating logic. In still other embodiments, the processing module 160 may be implemented in combination of hardware and software.

More specifically, the processing module 160 may be configured to determine that the measured ambient light is above a brightness threshold. Based on this determination, the processing module 160 may further determine that the brightness value of the screen light source 172 of the display screen 170 may need to be adjusted (e.g., increased), to compensate for the ambient light being above the brightness threshold. The processing module 160 may further determine the presence of reflection of the screen light to the display screen 170, based on the measurement of the one or more parameters indicative of the presence or absence of reflection 190 of the screen light 180 to the display screen 170. Accordingly, the processing module 160 may adjust or cause to be adjusted the brightness value of the screen light source 172, in response to the determination that the measurement of the ambient light is above the brightness threshold, and the determination of the presence of reflection 190 of the screen light 180 to the display screen 170, contributing to the ambient light measurement. For example, the processing module 160 may adjust or cause to be adjusted the brightness value of the screen light source 172 to a fixed value, e.g., about 20% of the maximum screen brightness value. In embodiments, the processing module 160 may be configured to determine the absence of reflection 190 of the screen light 180 to the display screen 170, based on the measurement of the one or more parameters indicative of the presence or absence of reflection 190 of the screen light 180 to the display screen 170. Accordingly, the processing module 160 may adjust or cause to be adjusted the brightness value of the screen light source 172, in response to the determination that the measurement of the ambient light is above the brightness threshold, and the determination of the absence of reflection 190 of the screen light 180 to the display screen 170.

For example, the processing module 160 may calculate a corresponding brightness value for the screen light source 172, based on the measurement of the ambient light, or retrieve the corresponding brightness value from a data storage (e.g., memory 106 or external storage accessible by the apparatus 100), based on the measurement of the ambient light.

FIG. 2 illustrates an example apparatus 200 configured with display screen light brightness adjustment, based in part on the presence or absence of reflection of the screen light to the display screen, in accordance with some embodiments. As shown, the apparatus 200 may comprise a laptop computer having a body 202 and a cover 204 including the display screen 170. A sensor 208, such as ALS sensor, may be configured to measure ambient light around the laptop 200. As shown, the screen light 180 may be reflected by a surface 150 comprising a keyboard side of the body 202 of the laptop 200, to provide the reflected screen light 190 back to the screen 170.

FIG. 3 illustrates another example apparatus 300 configured with display screen light brightness adjustment, based in part on the presence or absence of reflection of the screen light to the display screen, in accordance with some embodiments. As shown, the apparatus 200 may comprise a tablet computer, a smart phone, a PDA, or other mobile device having a body 302 including the display screen 170. A sensor 308, such as ALS sensor, may be configured to measure ambient light around the apparatus 300. As shown, the apparatus 300 may be placed at an angle 312 to a substantially horizontal surface (e.g., surface 150), for example, by leaning on an object 320. Similar to the example of FIG. 3, the screen light 180 may be reflected by a surface 150 comprising a reflective surface, to provide the reflected screen light 190 back to the screen 170.

As described in reference to FIG. 1, the example apparatuses 200 and 300 of FIGS. 2-3 may include sensor array 140 having sensors 110, 112, 114, coupled with the processing module 160. The processing module 160 may be stored in memory 106 and may be executable on the processor 104.

As shown in FIGS. 2 and 3, the screen light 180 may be reflected by the surface 150 feeding the ALS 208 (308) with the reflected screen light 190, which may lead to the operating system of the apparatus 200 (300) to increase the screen brightness, e.g., by increasing the brightness of the screen light source (not shown). As a result of the positive feedback, the screen light brightness may be adjusted to the maximum level.

Referring to FIG. 2, the screen light 180 may be reflected back to the display screen 170 (forming reflected screen light 190) under certain conditions, for example, when the display screen 170 is placed under an angle (e.g., below a pre-determined angle) to keyboard side of the body 202.

The sensors 110, 112, 114 may include an accelerometer to measure the posture of the laptop 200 (e.g., position of the body 202 relative to a horizontal plane), and/or a sensor to measure an angle 212 of the cover 204 having the display screen 170 relative to the body 202 of the laptop 200. For example, one of the sensors 110, 112, 114 may include a sensor to measure a rotation degree of a screen hinge 240, which may correspond to the angle 212. The processing module 160 may be configured to determine the presence of reflection 190 of the screen light 180 to the display screen 170 based at least in part on the measured angle 212. For example, the processing module 160 may determine the presence of reflection of the screen light to the display screen by establishing that the measured angle 212 is below a screen-to-body angle threshold (e.g., about 30 degrees). In embodiments, e.g., in the absence of the screen-hinge-angle sensor, it may be determined whether the body 202 is placed substantially horizontally (or under a predetermined angle to a horizontal plane). The determination of presence or absence of reflection may be made based on these factors or at least on the measured angle 212.

Referring to FIG. 3, the screen light 180 may be reflected back to the display screen 170 under certain conditions, for example, when the display screen 170 is placed proximate (e.g., at a distance below a pre-determined threshold) to a substantially horizontal surface and under an angle (e.g., below a pre-determined angle) to the surface (e.g., 150).

The sensors 110, 112, 114 may include a proximity sensor to measure a distance between the display screen 170 and an external object (e.g., surface 150). The sensors 110, 112, 114 may further include an accelerometer and/or gyroscope to provide measurements from which the angle of the body 302 of the apparatus 300 (e.g., the angle 312 of the display screen 170) to a substantially horizontal plane, such as surface 150, may be derived. Additionally or in the alternative, the sensors 110, 112, 114 may provide direct measurements of the angle 312.

The processing module 160 may determine that the measured distance between the display screen 170 and an external object (e.g., surface 150) is below a distance threshold. The processing module 160 may further determine that the angle of the display screen 170 to the horizontal plane is below a screen-to-horizontal plane threshold. Accordingly, the processing module 160 may determine the presence of reflection 190 of the screen light 180 to the display screen 170 based at least in part on the distance to the surface 150 (determined to be below the distance threshold) and angle 312 (determined to be below the screen-to-horizontal plane threshold).

The above-described methods of determining the presence of reflection of the screen light to the display screen of an apparatus (e.g., 200 or 300) may be described as indirect detection of the presence of reflection (or at least a possibility of the presence of reflection). As shown, indirect detection may be based on analysis of parameters that may indicate a presence or absence of reflection of the screen light to the display screen, such as angle of the display screen to a surface, proximity to the surface and the like. In the alternative to indirect detection, direct methods of detection of the presence of reflection of the screen light to the display screen (or possibility of such reflection) may be employed.

For example, the processing module 160 of the apparatus 200 or 300 may be configured to record (e.g., over a period of time) data indicating the measurements of the ambient light and corresponding adjustments of the screen light brightness values, and to determine the presence of reflection based at least in part on the recorded data. For example, the recorded ambient light measurements and corresponding adjustments the screen light brightness may be compared with known (e.g., stored) pattern corresponding to presence of positive feedback. The stored pattern may indicate, for example, that ambient light may be above a brightness threshold and may show continuous increase in brightness, and in response screen light may get brighter and brighter until it reaches maximum brightness. If the recorded measurements of the ambient light and corresponding adjustments of the screen light brightness values are determined to match the stored pattern (e.g., with a determined margin), positive feedback due to screen light reflection to the display screen may be determined.

In another example, the presence of screen light reflection (or a possibility of such presence) may be determined by adjusting screen light (e.g., by the processing module 160) according to a special pattern (e.g. the screen light may be made brighter and dimmer a few times over a period of time), and receiving corresponding measurements of ambient light from

ALS sensor. If the measured ambient light remains the same in response to manipulations with the screen light, it may be concluded that no screen light reflection affects the readings of the ambient light. If the measured ambient light responds to manipulations (e.g., increases or otherwise vacillates corresponding to the changes of the screen light brightness), it may be concluded that the reflected screen light affects the readings of the ambient light and, therefore, is present (or is likely present).

In another example, the presence of screen light reflection (or a possibility of such presence) may be determined by detecting a presence in the ambient light of a frequency pattern that may correspond to reflected light. For example, the processing module 160 may determine the presence of reflection of the screen light to the display screen based on the detected presence of a frequency pattern corresponding to reflected light. More specifically, a frequency pattern of a particular pulse-width-modulation (PWM) that may correspond to the reflected light may be detected, recognized, and filtered out.

In addition or in the alternative to direct or indirect detection of presence of the screen light reflection to the display screen of an apparatus, methods of prevention of the screen light reflection to the display screen of the apparatus may be employed. For example, if the apparatus includes logic to enable ALS to detect and filter out the screen light reflection (e.g., filter out light frequency pertaining to reflected screen light) from the ambient light readings, screen light reflection to the display screen and positive feedback may be avoided. Accordingly, ambient light readings provided the ALS may not be affected by the reflected screen light, and the screen light brightness may be adjusted to adapt to the ambient light readings provided by the ALS.

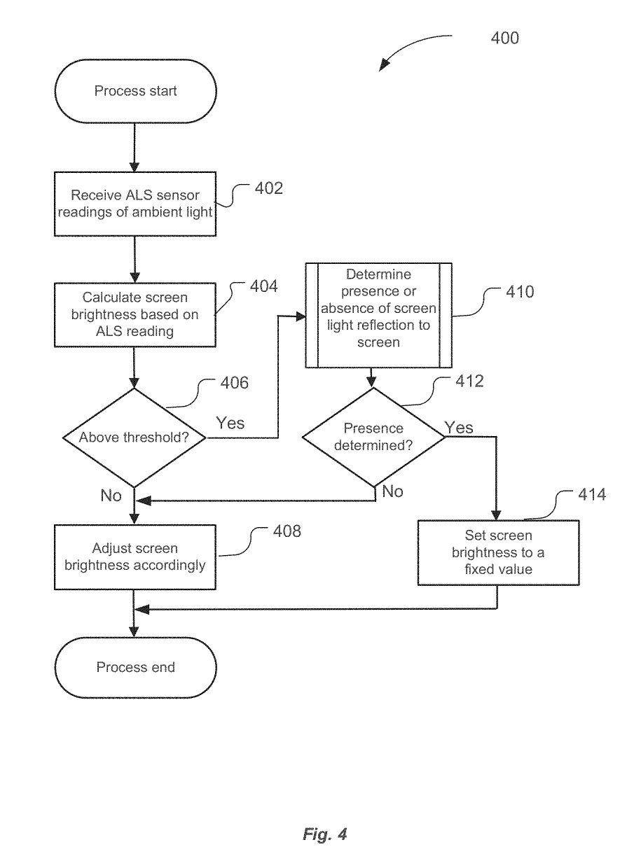

FIG. 4 is a process flow diagram for providing display screen light brightness adjustment, based in part on the presence or absence of reflection of the screen light to the display screen of an apparatus, in accordance with some embodiments. The process 400 may comport with and be performed by some of the elements of the various embodiments earlier described in reference to FIGS. 1-3. For example, the process may be performed by the processing module 160 of the apparatus 200 (300). In alternate embodiments, the process 400 may be practiced with more or less operations, or different order of the operations. The process 400 may be repeated periodically or performed continuously.

The process 400 may begin at block 402 and include receiving a reading of ambience light by an ALS sensor disposed on a display screen of an apparatus, such as apparatus 200 or 300.

At block 404, the process 400 may include calculating ambient light brightness based on the ALS reading.

At decision block 406, the process 400 may include determining whether the calculated ambient light brightness is above a pre-determined brightness threshold. If at decision block 406 the ambient light brightness is determined to be below brightness threshold, process 400 may continue at block 408. At block 408, the process 400 may include adjusting or causing to be adjusted display screen brightness according to the calculated ambient light brightness. For example, display screen brightness may be set to a corresponding adjustment value. For example, the corresponding brightness value may be calculated, based on the calculated ambient light brightness. In another example, the corresponding brightness value may be retrieved from a data storage accessible by the apparatus, based on the calculated ambient light brightness. Thereafter, process 400 may end.

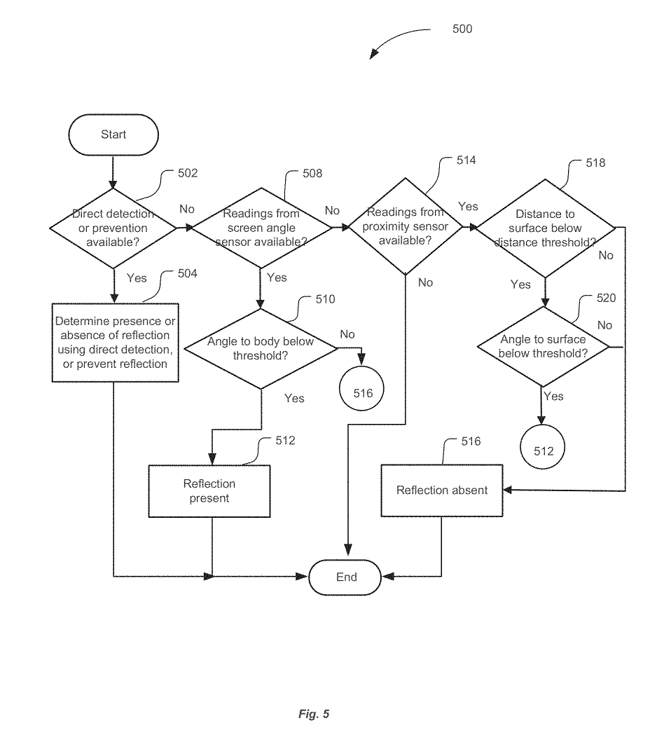

If at decision block 406 the ambient light brightness is determined to be above a brightness threshold, at block 410, the process 400 may include determining the presence or absence of reflection of the screen light to the display screen. As described in reference to FIGS. 2-3, the determining of the presence or absence of reflection of the screen light to the display screen may be conducted in a number of different ways. The process of block 410 will be described in greater detail in reference to FIG. 5.

At decision block 412, the process 400 may include determining whether the presence of reflection of the screen light to the display screen is determined as a result of operation of block 410.

If at decision block 412 the presence of reflection of the screen light to the display screen is determined, process 400 may continue at block 414. At block 414, the process 400 may include adjusting or causing to be adjusted the brightness value of the screen light, in response to the determination that the measurement of the ambient light is above the brightness threshold at block 406, and the determination of the presence of reflection of the screen light to the display screen at block 414. For example, the brightness value of the screen light may be adjusted or caused to be adjusted to a fixed value, such as about 20% of maximum brightness value of the screen light. Thereafter, process 400 may end.

If at decision block 412 the absence of reflection of the screen light to the display screen is determined, may continue at block 408. At block 408, the process 400 may include adjusting or causing to be adjusted the brightness value of the screen light, in response to the determination that the measurement of the ambient light is above the brightness threshold at block 406, and the determination of the absence of reflection of the screen light to the display screen at block 412. As described in reference to block 408, display screen brightness may be set to a corresponding adjustment value in a number of different ways. As described before, thereafter, process 400 may end.

FIG. 5 is a process flow diagram for determining presence or absence of reflection of the screen light to the display screen of an apparatus, in accordance with some embodiments. The process 500 may comport with and be performed by some of the elements of the various embodiments earlier described in reference to FIGS. 1-3. For example, the process may be performed by the processing module 160 of the apparatus 200 (300). The process 500 describes in detail the operations indicated by block 410 of FIG. 4.

The process 500 may begin at decision block 502 and include determining whether direct detection of presence or absence of reflection of the screen light to the display screen of the apparatus is available, or, in the alternative, whether prevention of reflection of the screen light to the display screen of the apparatus is available for application.

If it is determined at decision block 502 that direct detection or prevention of reflection is available, at block 504 at least one of the available mechanisms may be applied and reflection may be detected or prevented.

As described above, direct detection may include recording the measurements of the ambient light and corresponding adjustments of the screen light brightness values, comparing the recorded ambient light measurements and corresponding adjustments the screen light brightness with known (e.g., stored) pattern corresponding to a presence of positive feedback, and determining the presence of reflection based at least in part on the comparison.

Direct detection may further include manipulating screen light according to a special pattern and analyzing corresponding measurements of ambient light received in response to the manipulations.

Direct detection may further include detecting a presence of a component of ambient light with a determined frequency pattern (.e.g, PWM frequency pattern) that may correspond to reflected light, and accordingly determining the presence of reflection of the screen light to the display screen.

Prevention of the screen light reflection to the display screen of the apparatus may include detecting and filtering out the screen light reflection (e.g., filter out PWM frequency pattern pertaining to reflected screen light) from the ambient light readings.

If it is determined at decision block 502 that direct detection or prevention of reflection is not available, at decision block 508 it may be determined that the readings from a sensor providing measurements of a screen hinge angle (rotation degree) may be available. As described in reference to FIG. 2, such sensor may be provided for a computing device 200, such as laptop computer.

If it is determined at decision block 508 that the readings from a sensor providing measurements of a screen hinge angle (rotation degree) are available, it may be determined at decision block 510 whether the measured angle is below a screen-to-body angle threshold. Additionally, it may be determined whether the body is placed substantially horizontally (or under a predetermined angle to a horizontal plane). If at decision block 510 it is determined that the measured angle is below a screen-to-body angle threshold (and, in some embodiments, that the body of the computing device is placed substantially horizontally), the determination may be made at block 512 that reflection of the screen light to the display screen is present.

If at decision block 510 it is determined that the measured angle is equal to or greater than a screen-to-body angle threshold (and, in some embodiments, that the body of the computing device is placed substantially horizontally), the determination may be made at block 516 that reflection of the screen light to the display screen is absent.

If it is determined at decision block 508 that the readings from a sensor providing measurements of a screen hinge angle (rotation degree) are not available, it may be determined at decision block 514 whether readings from proximity sensor are available. If the readings from proximity sensor are available, it may be determined at decision block 518 whether the distance between the display screen of the apparatus (e.g., tablet computer, smartphone or other mobile device as described in reference to FIG. 3) is below a pre-determined distance threshold to an object. The object may comprise a surface from which the screen light may (or may not) reflect back to the display screen.

If the distance between the display screen of the apparatus and the object is determined to be equal to or greater than the distance threshold, the determination may be made at block 516 that reflection of the screen light to the display screen is absent.

If the distance between the display screen of the apparatus and the object is determined to be below the distance threshold, at decision block 520 it may be determined whether the angle of the display screen to the horizontal plane is below a screen-to-horizontal plane threshold.

If the angle of the display screen to the horizontal plane is determined to be below the screen-to-horizontal plane threshold, the determination may be made at block 512 that reflection of the screen light to the display screen is present. If the angle of the display screen to the horizontal plane is determined to be equal to or greater than the screen-to-horizontal plane threshold, the determination may be made at block 516 that reflection of the screen light to the display screen is absent.

FIG. 6 illustrates an example computing device 600 suitable for use with various components of FIG. 1, in accordance with some embodiments. In some embodiments, example computing device 600 may comprise apparatus 100, including various components of apparatus 100, such as the sensor array 140 including sensors 110, 112, 114, display 170, and processing module 160.

As shown, computing device 600 may include one or more processors or processor cores 602 and system memory 604. For the purpose of this application, including the claims, the terms “processor” and “processor cores” may be considered synonymous, unless the context clearly requires otherwise. The processor 602 may include any type of processors, such as a central processing unit (CPU), a microprocessor, and the like. The processor 602 may be implemented as an integrated circuit having multi-cores, e.g., a multi-core microprocessor. The computing device 600 may include mass storage devices 606 (such as solid state drives, volatile memory (e.g., dynamic random-access memory (DRAM), and so forth). In general, system memory 604 and/or mass storage devices 606 may be temporal and/or persistent storage of any type, including, but not limited to, volatile and non-volatile memory, optical, magnetic, and/or solid state mass storage, and so forth. Volatile memory may include, but is not limited to, static and/or dynamic random-access memory. Non-volatile memory may include, but is not limited to, electrically erasable programmable read-only memory, phase change memory, resistive memory, and so forth.

The computing device 600 may further include input/output (I/O) devices 608 (such as display 170 of FIG. 1), soft keyboard, touch sensitive screen, image capture device, and so forth) and communication interfaces 610 (such as network interface cards, modems, infrared receivers, radio receivers (e.g., Near Field Communication (NFC), Bluetooth, WiFi, 4G/6G LTE), and so forth). The I/O devices 608 may further include sensor array 140 with sensors 110, 112, 114, as shown.

The communication interfaces 610 may include communication chips (not shown) that may be configured to operate the device 600 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 610 may operate in accordance with other wireless protocols in other embodiments.

The above-described computing device 600 elements may be coupled to each other via system bus 612, which may represent one or more buses. In the case of multiple buses, they may be bridged by one or more bus bridges (not shown). Each of these elements may perform its conventional functions known in the art. In particular, system memory 604 and mass storage devices 606 may be employed to store a working copy and a permanent copy of the programming instructions implementing an operating system, including the operations associated with the apparatus 100, such as the processing module 160 of FIG. 1, and/or various applications, collectively denoted as computational logic 622. Computational logic 622 may be implemented in assembler instructions supported by processor(s) 602 or high-level languages that may be compiled into such instructions.

The permanent copy of the programming instructions may be placed into permanent storage devices 606 in the factory or in the field through, for example, a distribution medium (not shown), such as a compact disc (CD), or through communication interface 610 (from a distribution server (not shown)). That is, one or more distribution media having an implementation of the agent program may be employed to distribute the agent and to program various computing devices.

The number, capability, and/or capacity of the elements 608, 610, 612 may vary, depending on whether computing device 600 is used as a stationary computing device, such as a set-top box or desktop computer, or a mobile computing device, such as a tablet computing device, laptop computer, game console, or smartphone. Their constitutions are otherwise known, and accordingly will not be further described.

At least one of processors 602 may be packaged together with memory having computational logic 622 configured to practice aspects of embodiments described in reference to FIGS. 1-5. For one embodiment, at least one of processors 602 may be packaged together with memory having computational logic 622 to form a System in Package (SiP) or a System on Chip (SoC). For at least one embodiment, the SoC may be utilized in, e.g., but not limited to, a computing device such as a laptop, computing tablet or smartphone.

In various implementations, the computing device 600 may comprise a laptop, a netbook, a notebook, an ultrabook, a smartphone, a tablet, a personal digital assistant (PDA), an ultra mobile PC, or any other mobile computing device. In further implementations, the computing device 600 may be any other electronic device that processes data.

The embodiments described herein may be further illustrated by the following examples. Example 1 is an apparatus with screen light brightness adjustment, comprising: a display screen, wherein the display screen includes a screen light having a brightness value; one or more sensors disposed in the apparatus to measure ambient light and to measure one or more parameters indicative of a presence or absence of reflection of the screen light to the display screen; and a processing module coupled with the sensor module to adjust or cause to be adjusted the brightness value of the display screen light, based at least in part on the measurements of the ambient light and the one or more parameters indicative of the presence or absence of reflection of the screen light to the display screen.

Example 2 may include the subject matter of Example 1, wherein the processing module to adjust or cause to be adjusted the brightness value of the display screen includes to determine that the measured ambient light is above a brightness threshold.

Example 3 may include the subject matter of Example 2, wherein the processing module is to: determine the presence of reflection of the screen light to the display screen, based on the measurement of the one or more parameters; and adjust or cause to be adjusted the brightness value of the screen light, in response to the determination that the measurement of the ambient light is above the brightness threshold, and the determination of the presence of reflection of the screen light to the display screen, contributing to the ambient light measurement.

Example 4 may include the subject matter of Example 3, wherein the processing module to adjust or cause to be adjusted the brightness value of the screen light includes to adjust or cause to be adjusted the brightness value to a fixed value.

Example 5 may include the subject matter of Example 2, wherein the processing module is to: determine the absence of reflection of the screen light to the display screen, based on the measurement of the one or more parameters; and adjust or cause to be adjusted the brightness value of the screen light, in response to the determination that the measurement of the ambient light is above the brightness threshold, and the determination of the absence of reflection of the screen light to the display screen.

Example 6 may include the subject matter of Example 5, wherein the processing module to adjust or cause to be adjusted the brightness value of the screen light includes to: calculate a corresponding brightness value, based on the measurement of the ambient light, or retrieve the corresponding brightness value from a data storage accessible by the apparatus, based on the measurement of the ambient light.

Example 7 may include the subject matter of Example 1, wherein the one or more sensors to measure one or more parameters includes to measure an angle of the display screen relative to a body of the apparatus, wherein the processing module is to determine the presence of reflection of the screen light to the display screen based at least in part on the measured angle.

Example 8 may include the subject matter of Example 7, wherein the processing module to determine the presence of the reflection of the screen light to the display screen further includes to determine that the measured angle is below a screen-to-body angle threshold.

Example 9 may include the subject matter of Example 1, wherein the one or more sensors to measure one or more parameters includes to determine a distance between the display screen and an external object, wherein the processing module is to determine the presence of reflection of the screen light to the display screen based at least in part on the determined distance.

Example 10 may include the subject matter of Example 9, wherein the processing module to determine the presence of reflection of the screen light includes to determine that the determined distance is below a distance threshold.

Example 11 may include the subject matter of Example 10, wherein the one or more sensors is further to determine an angle of the display screen to a horizontal plane, wherein the processing module to determine the presence of the reflection of the screen light further includes to determine that the angle of the display screen to the horizontal plane is below a screen-to-horizontal plane threshold.

Example 12 may include the subject matter of Example 1, wherein the one or more sensors to measure one or more parameters includes to detect a presence of a component of light with a determined frequency, wherein the processing module is to determine the presence of reflection of the screen light to the display screen based at least in part on the detected presence of the component of light with the determined frequency.

Example 13 may include the subject matter of Example 1, wherein the processing module is further to record data indicating the measurements of the ambient light and corresponding adjustments of the brightness values, and to determine the presence of reflection based at least in part on the recorded data.

Example 14 may include the subject matter of Example 1, wherein the one or more sensors comprise at least a selected one of: an ambient light sensor (ALS), a gyroscope, a proximity sensor, screen hinge rotation degree measurement sensor, or accelerometer. Example 15 may include the subject matter of Example 14, wherein the apparatus comprises one of: a laptop computer, a tablet computer, or a smart phone.

Example 16 may include the subject matter of any of Examples 1 to 15, wherein the one or more sensors to measure ambient light includes to measure at least one of: ambient light intensity or ambient light frequency.

Example 17 is one or more non-transitory computing device-readable media having executable instructions stored thereon that, in response to execution, cause a computing device to provide a processing module to: obtain, from one or more sensors disposed in the computing device, readings of ambient light and one or more parameters indicative of a presence or absence of reflection of a screen light to a display screen of the computing device; determine that the measured ambient light is above a threshold; and adjust or cause to be adjusted the brightness value of the display screen based on the readings of the ambient light and the one or more parameters indicative of the presence or absence of reflection of the screen light to the display screen of the computing device.

Example 18 may include the subject matter of Example 17, wherein the instructions further provide the processing module to: determine the presence of reflection of the screen light to the display screen, based on the measurement of the one or more parameters; and adjust or cause to be adjusted the brightness value of the screen light, in response to the determination that the measurement of the ambient light is above the brightness threshold, and the determination of the presence of reflection of the screen light to the display screen, contributing to the ambient light measurement.

Example 19 may include the subject matter of Example 18, wherein the processing module to adjust or cause to be adjusted the brightness value of the screen light includes to adjust or cause to be adjusted the brightness value to a fixed value, wherein the fixed value comprises about 20% of a maximum brightness value.

Example 20 may include the subject matter of any of Examples 17 to 19, wherein the instructions further provide the processing module to: determine the absence of reflection of the screen light to the display screen, based on the measurement of the one or more parameters; and adjust or cause to be adjusted the brightness value of the screen light, in response to the determination that the measurement of the ambient light is above the brightness threshold, and the determination of the absence of reflection of the screen light to the display screen.

Example 21 is a computer-implemented method for adjusting display screen brightness, comprising: obtaining, by a computing device, from one or more sensors disposed in the computing device, readings of ambient light and one or more parameters indicative of presence or absence of reflection of a screen light to a display screen of the computing device;

determining, by the computing device, that the measured ambient light is above a threshold; and adjusting, or causing to adjust, by the computing device, the brightness value of the display screen based on the readings of the ambient light and the one or more parameters indicative of the presence or absence of the reflection of the screen light to the display screen of the computing device.

Example 22 may contain the subject matter of Example 21, further comprising: determining, by the computing device, the presence of reflection of the screen light to the display screen, based on the one or more parameters; and adjusting or causing to be adjusted, by the computing device, the brightness value of the screen light, in response to the determination that the measurement of the ambient light is above the brightness threshold, and the determination of the presence of reflection of the screen light to the display screen, contributing to the ambient light measurement.

Example 23 may contain the subject matter of Example 21, further comprising: determining, by the computing device, the absence of reflection of the screen light to the display screen, based on the one or more parameters; and adjusting or causing to be adjusted, by the computing device, the brightness value of the screen light, in response to the determination that the measurement of the ambient light is above the brightness threshold, and the determination of the absence of reflection of the screen light to the display screen.

Example 24 is an apparatus for adjusting display screen brightness, comprising: means for obtaining, from one or more sensors disposed in the computing device, readings of ambient light and one or more parameters indicative of presence or absence of reflection of a screen light to a display screen of the computing device; means for determining, that the measured ambient light is above a threshold; and means for adjusting, or causing to adjust, the brightness value of the display screen based on the readings of the ambient light and the one or more parameters indicative of the presence or absence of the reflection of the screen light to the display screen of the computing device.

Example 25 may contain the subject matter of Example 24, further comprising: means for determining the presence of reflection of the screen light to the display screen, based on the one or more parameters; and means for adjusting or causing to be adjusted, the brightness value of the screen light, in response to the determination that the measurement of the ambient light is above the brightness threshold, and the determination of the presence of reflection of the screen light to the display screen, contributing to the ambient light measurement.

Example 26 may contain the subject matter of Example 24, further comprising: means for determining the absence of reflection of the screen light to the display screen, based on the one or more parameters; and means for adjusting or causing to be adjusted, the brightness value of the screen light, in response to the determination that the measurement of the ambient light is above the brightness threshold, and the determination of the absence of reflection of the screen light to the display screen.

Various operations are described as multiple discrete operations in turn, in a manner that is most helpful in understanding the claimed subject matter. However, the order of description should not be construed as to imply that these operations are necessarily order dependent. Embodiments of the present disclosure may be implemented into a system using any suitable hardware and/or software to configure as desired.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

1. An apparatus with screen light brightness adjustment, comprising:
a display screen, wherein the display screen includes a screen light having a brightness value;
one or more sensors disposed in the apparatus to measure ambient light and to measure one or more parameters indicative of a presence or absence of reflection of the screen light to the display screen; and
a processing module coupled with the sensor module to adjust or cause to be adjusted the brightness value of the display screen light, based at least in part on the measurements of the ambient light and the one or more parameters indicative of the presence or absence of reflection of the screen light to the display screen.

2. The apparatus of claim 1, wherein the processing module to adjust or cause to be adjusted the brightness value of the display screen includes to determine that the measured ambient light is above a brightness threshold.

3. The apparatus of claim 2, wherein the processing module is to:
determine the presence of reflection of the screen light to the display screen, based on the measurement of the one or more parameters; and
adjust or cause to be adjusted the brightness value of the screen light, in response to the determination that the measurement of the ambient light is above the brightness threshold, and the determination of the presence of reflection of the screen light to the display screen, contributing to the ambient light measurement.

4. The apparatus of claim 3, wherein the processing module to adjust or cause to be adjusted the brightness value of the screen light includes to adjust or cause to be adjusted the brightness value to a fixed value.

5. The apparatus of claim 2, wherein the processing module is to:
determine the absence of reflection of the screen light to the display screen, based on the measurement of the one or more parameters; and
adjust or cause to be adjusted the brightness value of the screen light, in response to the determination that the measurement of the ambient light is above the brightness threshold, and the determination of the absence of reflection of the screen light to the display screen.

6. The apparatus of claim 5, wherein the processing module to adjust or cause to be adjusted the brightness value of the screen light includes to:
calculate a corresponding brightness value, based on the measurement of the ambient light, or
retrieve the corresponding brightness value from a data storage accessible by the apparatus, based on the measurement of the ambient light.

7. The apparatus of claim 1, wherein the one or more sensors to measure one or more parameters includes to measure an angle of the display screen relative to a body of the apparatus, wherein the processing module is to determine the presence of reflection of the screen light to the display screen based at least in part on the measured angle.

8. The apparatus of claim 7, wherein the processing module to determine the presence of the reflection of the screen light to the display screen further includes to determine that the measured angle is below a screen-to-body angle threshold.

9. The apparatus of claim 1, wherein the one or more sensors to measure one or more parameters includes to determine a distance between the display screen and an external object, wherein the processing module is to determine the presence of reflection of the screen light to the display screen based at least in part on the determined distance.

10. The apparatus of claim 9, wherein the processing module to determine the presence of reflection of the screen light includes to determine that the determined distance is below a distance threshold.

11. The apparatus of claim 10, wherein the one or more sensors is further to determine an angle of the display screen to a horizontal plane, wherein the processing module to determine the presence of the reflection of the screen light further includes to determine that the angle of the display screen to the horizontal plane is below a screen-to-horizontal plane threshold.

12. The apparatus of claim 1, wherein the one or more sensors to measure one or more parameters includes to detect a presence of a component of light with a determined frequency, wherein the processing module is to determine the presence of reflection of the screen light to the display screen based at least in part on the detected presence of the component of light with the determined frequency.

13. The apparatus of claim 1, wherein the processing module is further to record data indicating the measurements of the ambient light and corresponding adjustments of the brightness values, and to determine the presence of reflection based at least in part on the recorded data.

14. The apparatus of claim 1, wherein the one or more sensors comprise at least a selected one of: an ambient light sensor (ALS), a gyroscope, a proximity sensor, screen hinge rotation degree measurement sensor, or accelerometer.

15. The apparatus of claim 14, wherein the apparatus comprises one of: a laptop computer, a tablet computer, or a smart phone.

16. The apparatus of claim 1, wherein the one or more sensors to measure ambient light includes to measure at least one of: ambient light intensity or ambient light frequency.

17. One or more non-transitory computing device-readable media having executable instructions stored thereon that, in response to execution, cause a computing device to cause a processing module to:
obtain, from one or more sensors disposed in the computing device, readings of ambient light and one or more parameters indicative of a presence or absence of reflection of a screen light to a display screen of the computing device;
determine that the measured ambient light is above a threshold; and
adjust or cause to be adjusted the brightness value of the display screen based on the readings of the ambient light and the one or more parameters indicative of the presence or absence of reflection of the screen light to the display screen of the computing device.

18. The non-transitory computing device-readable media of claim 17, wherein the instructions further cause the processing module to:
determine the presence of reflection of the screen light to the display screen, based on the measurement of the one or more parameters; and
adjust or cause to be adjusted the brightness value of the screen light, in response to the determination that the measurement of the ambient light is above the brightness threshold, and the determination of the presence of reflection of the screen light to the display screen, contributing to the ambient light measurement.

19. The non-transitory computing device-readable media of claim 18, wherein the processing module to adjust or cause to be adjusted the brightness value of the screen light includes to adjust or cause to be adjusted the brightness value to a fixed value, wherein the fixed value comprises about 20% of a maximum brightness value.

20. The non-transitory computing device-readable media of claim 17, wherein the instructions further cause the processing module to:
determine the absence of reflection of the screen light to the display screen, based on the measurement of the one or more parameters; and
adjust or cause to be adjusted the brightness value of the screen light, in response to the determination that the measurement of the ambient light is above the brightness threshold, and the determination of the absence of reflection of the screen light to the display screen.

21. A computer-implemented method for adjusting display screen brightness, comprising:
obtaining, by a computing device, from one or more sensors disposed in the computing device, readings of ambient light and one or more parameters indicative of presence or absence of reflection of a screen light to a display screen of the computing device;
determining, by the computing device, that the measured ambient light is above a threshold; and
adjusting, or causing to adjust, by the computing device, the brightness value of the display screen based on the readings of the ambient light and the one or more parameters indicative of the presence or absence of the reflection of the screen light to the display screen of the computing device.

22. The computer-implemented method of claim 21, further comprising:
determining, by the computing device, the presence of reflection of the screen light to the display screen, based on the one or more parameters; and
adjusting or causing to be adjusted, by the computing device, the brightness value of the screen light, in response to the determination that the measurement of the ambient light is above the brightness threshold, and the determination of the presence of reflection of the screen light to the display screen, contributing to the ambient light measurement.

23. The computer-implemented method of claim 21, further comprising:
determining, by the computing device, the absence of reflection of the screen light to the display screen, based on the one or more parameters; and
adjusting or causing to be adjusted, by the computing device, the brightness value of the screen light, in response to the determination that the measurement of the ambient light is above the brightness threshold, and the determination of the absence of reflection of the screen light to the display screen.
